(19) United States
(12) Patent Application Publication
(10) Pub. No.: US 2018/0136347 A1
(43) Pub. Date: May 17, 2018

(54) Solid State Structure and Method for Detecting Neutrinos

(71) Applicant: John S Lechaton, Englewood, FL (US)

(72) Inventor: John S Lechaton, Englewood, FL (US)

(21) Appl. No.: 15/258,137

(22) Filed: Sep. 7, 2016

(51) Int. Cl. G01T 1/24; G01T 1/26

(52) U.S. Cl. CPC G01T 1/247; G01T 1/244; G01T 1/26

(57) ABSTRACT

A solid state device and method are described for detecting and using neutrinos. In elementary particle physics there are only three stable particles: the proton, electron and neutrino. The proton and electron have a “charge q” and are easy to detect, but neutrinos have no charge but a magnetic moment (spin ½) and does not strongly interact with matter at room temperature (295° Kelvin). This neutrino detector consists of a semiconducting substrate, with magnetic atoms at the lattice sites. An important feature of this disclosure is that it functions at cryogenic temperatures (0° to 78° K) using the Kondo effect which forms hybrid localized milli-eV band (about 20-40×10⁻³ eV) at the magnetic sits in the semiconductor band gap or conduction band. The neutrinos passing the detector and absorbed at these sites change the resistance of the neutrino detector. In a second embodiment a superconductor is used. The preferred material is a high temperature superconductor (<77° K) such as YBa₂Cu₃O₇₋ₓ. The neutrinos dissociate the Cooper pair (electrons) and change the resistance that is measured as in the first embodiment.

### FIELD

This disclosure provides a novel Solid State structure and method for detecting neutrinos that result from beta decay.

### BACKGROUND

The neutrino is one of the three stable elementary particles in particle physics that makes up most of the universe. The other two stable particles are the proton and electron (see any book on elementary particle physics). Since the electron and proton have a charge, they strongly interact with all forms of matter and are easy to detect. On the other hand, the neutrino has a magnetic moment (spin ½) but NO charge and, therefore, at normal temperature (room temps.) passes through most matter without interacting. Current methods of detecting these charge-less particles (neutrinos ν) require massive volumes of water or heavy water (DO₂) deep in the ground and thousands of detectors to detect the occasional interaction of the neutrino with a nucleus of the hydrogen atom in the water.

### DESCRIPTION OF THE RELATED ART

Several methods for detecting and utilizing neutrinos have been proposed or reported in the literature. For example, U.S. Pat. No. 8,849,565 B1 by G. M. Gutt (2014) describes a method for a Navigation System Based on Neutrino Detection and tracking neutrinos from the Sun. The method is proposed for detecting neutrinos, for example, from the sun and determining their angle of arrival for navigational information. The inventor is silent about the method of detecting the neutrinos.

Another patent more closely related to this patent is U.S. Pat. No. 4,968,475 by Drukier et al. which describes a method and apparatus for the detection of neutrinos and use for neutrino detection. In Drukier's et al patent superconducting grains are imbedded in a dielectric matter and wire pick-up loops extending through the dielectric in both the x and y directions to detect the change in magnetic state when a neutrino interacts and raises the temperature of the superconducting grain to a non-superconducting state (Meissner effect).

Another paper that addresses the Kondo effect at low temperature is “Is FeSi a Kondo insulator” by Z. Schlesinger et al. in Physica B published by Elsevier 1997. However, the authors are silent about and do not address the use of the Kondo effect for detecting neutrinos.

In still another U.S. Pat. No. 6,891,310 B2 by Beckwith entitled “Neutrino Light to Photon Light Converting Matrix” The inventor purports to be able to detect neutrinos using an engineering model in which there are six coordinates. Four are x, y, z coordinates and, time and the other two are the electric and magnetic fields E and H. However, in physics the electric and magnetic fields are represented in Euclidian space as Eₓ, E_{y} and, E_{z}. However, Beckwith's approach for detecting neutrinos is reasonable compared to the current STD model which assumes the existence of neutrinos based on experimental evidence. Beckwith's approach in using Euclidian geometry is reasonable, since Cosmic Back Microwave Radiation (CBMR) of the known universe has been found to be very flat and uniform and not a curved space (Riemannian geometry). Also the STD model with its quarks, gluon, virtual electrons and maybe leprechaun fails the metaphysical test for reality and does not address Einstein's question “What is an electron?”. Also, Beckwith in his FIG. 2 depicts all the elementary particles (P, e and ν) and includes Cooper pairs as a plus 2 charge which is used in super-conductivity that results from phonon coupling (electron pairing). Beckwith proposes using the piezoelectric effect to detect neutrinos. However, he is silent about using very low temperatures necessary to create Cooper pairs to detect neutrinos, which may not be very important as part of his disclosure. There are some aspects of his invention which are consistent with this inventor/authors paper that propose that the three elementary stable particles can be formed from only the electric E and magnetic H field. Beckwith references work that was carried out at Nottingham University and confirmed at the High Magnetic Fields Lab. at Florida Univ. in Gainesville Fla. The experiment showed that very high magnetic fields result in levitation. Beckwith proposed that there was a strong near field that is associated with the atomic structure (electrons and protons) and far weak field that was associated with gravitation and neutrinos.

However, there is still a strong need in basic research, development, and future commercial applications to have a more efficient way to detect neutrinos than the current very costly method cited above. There is also a need to detect the low energy neutrinos that is missed by the current method in heavy water (ν->DO₂). Furthermore, it would be ideal to use the more abundant elements (Fe, Si) in the Periodic Table, since Fe is the end product of most exploding stars Fe (mass #56) and Si with a mass #26 are the more abundant elements available on earth and elsewhere in the Universe for advanced civilization (aliens) to use. Also, very high purity Si substrates (7/9 to 9/9) are available in the semiconductor industry for making integrated circuits.

### SUMMARY

This disclosure is based on a proposed model (ongoing and unpublished paper), by the inventor/author, that is a possible alternative model for the stable elementary particles (Protons, Electrons and Neutrinos). These neutrinos result from radioactive decay that involves the weak electromagnetic fields. The neutrino detection structure consists of a semiconductor or insulator doped with magnetic impurity atoms, such a Fe, Ni, Co, and the like. The structure utilizes the magnetic atoms at the lattice sites in the semiconductor to form localized micro-bands (between about 20 and 60×10⁻³ eV wide) near or in the semiconductor conduction band (Kondo effect). These sites capture the neutrinos which have ZERO charge but have a magnetic moment with spin ½. The neutrino energy captured at these sites changes the conductivity (resistance) of the solid state device. The change in the resistively is easily measured using a conventional multimeter. Both the neutrino detection structures (e.g., FeₓSiₓ₋₁) and silicon integrated circuits (devices) formed from n and p doped silicon can be fabricated on the same Si substrate. Since very low temperatures (approaching 0° K) are required for neutrino detection and silicon integrated circuits function well at these low temperature, both can be fabricated on the same chip or substrate. This disclosure is ideal for outer space where the Cosmic Microwave Background Radiation (CMBR) temperature is 3.56° Kelvin.

In a second embodiment a high temperature superconducting material (e.g., YBaCu₃O₇₋ₓ) at about 78° K or a lower temperature superconductor is used as the neutrino detector at a low temperature in the superconducting state. The neutrinos which must have energy and mass (Phil. 201, metaphysics) dissociate the paired electrons (Cooper pair) due to phonon coupling, and thereby increase the resistance of the superconductor. At the lower CMBR temperatures (Cosmos), other low temperature superconductors can also be used, such as V₃Si (17.1° K), Nb₃Al (17.7° K), and the like.

The proposed model is based on quantizing Maxwell's equations ∇xE=μ∂H/∂t and ∇xH=ε∂E/∂t that incorporate the Poynting vector P=HXE and Planck's quantum equation (E=hν). The constants μ and ε are the magnetic and electric constants of “empty space” or “vacuum”. These constants represent the capacitance C and inductance L properties of Aristotle Aether or today's CMBR that fills this “empty space”.

The method proposed to model the elementary particles (e⁻, P⁺ and ν⁰) is analogous to the way that Schrödinger's equation was applied to the hydrogen atom to describe the electron energy level using Euclidian algebra with spherical coordinates (see “Introduction to Atomic Spectra” by White, Pub. McGraw Hill 1934). The inventor's unpublished paper was motivated by principles of metaphysics (Philosophy 201) and Infeld and Einstein's (1943) suggestion that elementary particles must be comprised of high-intensity fields and not matter with fields (see “The Evolution of Physics”, Infeld & Einstein, pages 242-243, published by Simon and Schuster 1938). Based on metaphysical and cosmological principles (Phil. 201), the essence of all the stable elementary particles including the neutrino must be a real measurable field. More specifically, the only known measurable fields are the electric and magnetic fields designated by the vector fields as E and H. By interchanging the fields, H->E and E->H in the inventor's proposed model, the antiparticles are formed for the Proton, electron and neutrino and further lead to the basis or reason in the proposed model for explaining the Paule exclusion principle and quantum entanglement. Furthermore, the model would result in zero or very small dipole moments on the electron, proton and neutrino. The elementary particles (Fermions) and antiparticles (Fermions) would annihilate to form pure EM energy (spin ½/−½=spin 0 or 1, bosons).

Also, in this model the operators (∇ and ∂/∂T) are applied to the real entities E and H and not to the hypothetical entities (ψ) as in Schrödinger's equation that is not real. In Schrödinger's equation the imaginary or theoretical entities (ψ) are then squared and normalized and assumed to represent the probability of finding a particle (electron) in a unit volume (atom). The Schrödinger's eq. works well to describe the Hydrogen atom, using an electron e and proton P as point particles (0×0×0) with a negative charge −q on electron and a +q on the proton and obeying Coulomb's inverse sq. law. However, Schrödinger's eq. requires Euclidean spherical coordinates (r, Q, ψ) to generate the electron quantum levels (n, l and m) in a Hydrogen atom. If your smart phone goes dead and you can't find any Schrödinger electrons, you can always find some real Maxwell electrons in your electrical outlet on the wall.

Also, Planck's quantum equation, E=hν, relates the energy E to a frequency of the electromagnetic field H×E and is independent of any wavelength λ. Therefore, the ongoing model does not depend on the distance in space (e.g., centimeters), and the Lorentz-Fitzgerald contraction [1−(V/C)²] is not necessary. The classical solution of Maxwell's Eq. leads to the speed of light C being equal to 1/(μ×ε)^{1/2}. Therefore, the speed of light which is an electromagnetic wave (H×E) is a function of the dielectric media it propagates in. In this case the CBMR that fills space. The Lorentz-Fitzgerald contraction may be a fortuitous (accidental) result that is not correct. This leads to a paradox or contradiction, and the assumption that the mass and time of a particle transform in this way is contrary to Aristotle's metaphysics and logic.

If the Inventor/Author's proposed model is correct, then one can expand a standing wave H×E field (e.g., in a Taylor or Fourier series) one should get the long (gravitation fields) and short electromagnetic fields (H×E) as proposed in the reference cited below in R. B. Beckwith, s (patent) invention.

Also, in the early stages of the Big Bang the very high temperature (P=E×H) would have formed neutrinos and anti-neutrinos (no charge) that expanded first to create the very uniform universe (inflation) we see today. As the universe further cooled the high electromagnetic energy (H×E) condensed out to form electrons e⁻ and protons P⁺ of equal charge and having the neutrino as their essence. However, the proposed model uses two real fields (Phil. 201, realist) and avoids non-real abstract entities, such as quantizing an abstract continuous wave ψ, and assuming (postulate) |ψ|² as a statistical probability for the electron.

Relevant to this disclosure are two pieces of nuclear data. One is the ratio of neutrons N to protons P (N/P), and the binding energy of the atomic nucleus with increasing nuclear mass M. Referring to “Introductory Nuclear Physics” by D. Halliday 1950 by John Wiley & Sons on page 9 the number of neutrons vs. protons for nuclei increases by about 50/50 for elements up to Fe (M=55.847). In elements with higher mass numbers, including the rare earth elements, the neutrons/proton ratio increases gradually to about 150/100 to maintain more stable heavier elements. Also, on page 261 of Halliday's book the maximum in the binding energy curve is at nuclear mass #56 which is Fe. In the Sun and other stars in the universe hydrogen fuses (P+P=D+e⁺+ν) to form the heaver elements and the heaver nuclei fusion results in beta decay with creation of neutrinos to conserve energy and momentum.

An example of the simplest unstable elementary particle is the free neutron N that decays into these three stable elementary particles: the proton, electron and antineutrino (N=>P⁺+e⁻+ν) with a half-life of about 14 min. The only place where the neutron is stable is inside a nucleus of an atom. The reaction products are the only stable elements that comprise the cosmos (Universe) other than the nuclei formed in all stars including our star (see any periodic table of the elements). When a nucleus decays by β decay, one of the neutrons changes to a proton and emits an electron and antineutrino to conserve energy and spin, and the nucleus charge Q increases by one positive charge to conserve charge Q.

Also, if one wishes to search for the God particle (Phil/Theology 401) one may wish to consider the proton P which has been around since the Big Bang (creation), the electron as the angel and the neutrino as the Holy Ghost.

A principal object of this disclosure is to provide a solid state structure for detecting neutrinos that is cheaper and more efficient than the current method. In a first embodiment, a semiconductor doped with ferromagnetic impurities (Kondo sites) is used to provide sites for capturing neutrinos. The change in conductivity (resistive) of the magnetically doped semiconductor is measured to determine the change in the neutrino flux.

A second object of this disclosure is to provide a neutrino shutter to block or modulate the neutron beam.

A third object of this disclosure by a second embodiment is to use a superconductor and to monitor the change in the resistively due to a change in the dissociation of the Cooper electron pairs by a portion of the neutrino flux passing through the superconductor. One preferred superconductor is a high temperature superconductor such as (<77° K) YBa₂Cu₃O₇₋ₓ. Also, at lower temperatures some of the more common elements and alloys can be used. For example, in outer space where the CMBR is 3.56° K, other low temperature superconductors can be used. For example, Pb (7.19° K), V (5.03° K), Ta (4.48° K) etc. or some compound like V₃Si (17.1° K), Nb₃Al and the like which have a critical transition temp. (Tₐ) above the CMBR temperature.

A fourth object of this disclosure is to fabricate a neutrino propulsion system by absorbing and/or redirecting the neutrino flux. The first generation flying saucer most likely use electromagnetic energy as a means of propulsions, such as Tesla's “death ray” or more likely Tesla's attempt to transmitted power over long distances. The second generation flying saucer would use neutrinos as a source of propulsion, especially in outer space where the temperature is about 3.54° K and the above materials can function in their Kondo or superconducting state.

In accordance with the above principal objective of the present disclosure, a structure and method for making a Neutrino detector is described. One preferred method is to use conventional alloying to make a Si/Fe alloy using a conventional induction furnace. Alternatively, and a more preferred method is to deposit Fe on a single crystal silicon (Si) substrate using chemical vapor deposition (CVD) or implanting and annealing to form an alloy. The substrate is then annealed resulting in the Fe atoms to migrate (diffuse) to the Si lattice sites from the interstice sites. This annealing results in the Fe atoms forming shallow localized band (wells) near or in the Si conduction band that are about 10-60×10⁻³ eV in width. These shallow bands are the result of the hybridizing of the outer electron shells of Fe (d or f electron shell) with the Si conduction band (heavy electrons) or in the Fermi band cap near the conduction band. These solids having this hybrid band structure are commonly referred to as Kondo semiconductors or Kondo insulators. Since our sun is similar to other stars these materials would be available in any galaxy in the Universe (see periodic table) for advanced civilizations (aliens) to use. Further, if Einstein was not misdirected by Michael and Morley's faulty experimental results, he would have concentrated on Maxwell's equations, the electric and magnetic constants (ε, μ), and the CBMR that fills space with an electromagnetic energy (H×E) and neutrinos and he would have realize that “space” like zero (0) fails a reality test (Phil. 201, metaphysics).

In this disclosure the Neutrinos then interact with the magnetic Fe sites to increase the number of electrons (referred to as heavy electrons) in the Si conduction band. This results in an increase in conductivity or decrease in the resistively due to change in the neutrino flux pass through the Fe doped Silicon substrate (neutrino detector).

An important requirement is to operate the neutrino detector at very low temperatures (<<240 K and more likely at ˜0-20° K). These temperatures near 0° K (Kelvin) are readily available in outer space since the Cosmos Background Microwave Radiation (CBMR) has a temperature of only 3.5 degrees Kelvin. To achieve these temperatures on earth it is necessary to use an isolated cryogenic system to sufficiently cool the detector.

The second objective of this disclosure is to making a neutrino shutter. The shutter is preferably fabricated from the same material as the neutron detector to block or modulate the neutron beam and operates at the same low temperature near 0° Kelvin.

The third objective of this disclosure is to create a neutrino detector using a superconductor. One preferred method is to use a high temperature (78° Kelvin) superconductor which can be achieved at liquid nitrogen temperatures. An alternative is to a low temperature superconductor using cryogenic methods. Both utilize the disassociation of the Cooper pair to detect the neutrinos. In this second embodiment the goal is to measure directly the change in resistance of the superconductor directly rather than indirectly, as proposed in the prior art, by Druier et al., rather than detecting a change in magnetic field due to the Messier effect.

### BRIEF DESCRIPTION OF THE DRAWINGS

FIG. 1 shows a schematic cross section of a neutrino detector composed of a doped semiconductor substrate with magnetic doped sites and a means for measuring a change in resistance.

FIG. 2 shows the same schematic cross section as the device in FIG. 1 with a neutrino shutter to change or modulate the neutrino flux density.

FIG. 3 shows a top view of a portion of the neutrino detector with a cross section 3-3′ through one of the many magnetic atoms (site) at the semiconductor lattice site.

FIG. 4 shows a cross section view 3-3′ through the magnetic site showing the shallow energy band structure created by the magnetic atom outer shell (d or f shells) in FIG. 3 relative to the semiconductor conduction band vs. distance in the substrate.

FIG. 5 shows a plot of resistance vs. energy using infrared and Raman spectroscopy frequencies and for temperature at 250° and 20° Kelvin showing the narrow band of about 35×10⁻³ eV due to the Kondo effect in FeSi.

FIG. 6 shows a cross section of a superconducting neutrino detector which is similar to FIG. 1 but with the magnetically doped semiconductor replaced with a superconductor.

### DETAILED DESCRIPTION

The method for making these neutrino detector devices is now described in more detail with reference to the FIGS. 1-6 listed above. The neutrino device and the instrumentation for measuring and storing the data is described using separate electron equipment, but for single crystal Si substrates the measuring devices can be used to integrated in with the current integrated semiconductor devices on the same silicon substrate.

Referring first to FIG. 1, a cross sectional view of a neutrino detector is shown composed of a semiconductor substrate 2 with magnetic doped sites 6. The thickness of the substrate is labeled Z. The semiconductor substrate is preferably silicon (Si) and the magnetic sites are preferably iron atoms (Fe). One of the Fe sites is depicted as 6 in FIG. 1. Also depicted is a neutrino flux 4 impinging on the detector 2 from an external source such as from the sun, nuclear reactors, particle accelerators or the Cosmos. One method of forming this Si/Fe alloy is by means of conventional alloying in an induction furnace. However, the preferred method is to deposit Fe using chemical vapor deposition (CVD), or sputter deposition on a Si substrates (wafers) that are currently used in the semiconductor industry. Still another method is to implant Fe into the Si substrate and anneal to activate the Fe at the Si crystalline sites. If semiconductor devices are included on the same substrates, the substrates are preferably cleaved along the <100> crystal orientation and have a very low impurity level 99.9999999 (7/9 or 9/9) are preferred. These silicon substrates are ideal since the neutrino detector can be integrated into the same substrates as the semiconductor devices.

Also, as shown in FIG. 1 the change in neutrino flux through Fe/Si neutrino detector device 2 can be measured using separate instruments. For example, a multimeter 10 for measuring a change in resistance can be connected across the device using ohmic contacts 8, such as Pt silicide contacts, as is commonly used for silicon integrated circuits.

The change in resistance is due to a change in neutrino flux 4. The change in resistance can be further analyzed using an analog to digital (A/D) converter 12 and a computer 14 for collecting and storing the neutrino data. However, one can also integrate these electronic circuits on a single “chip” or substrate with the neutrino detector since the integrated circuits performs very well at very low temperature which is required for the Fe/Si neutrino detector. Although, one can use the 50/50 composition of Fe/Si v phase (see “Is FeSi a Kondo insulator, Z. Schlesinger et al in Physica B pages 460-461, published by Elsevvier), the Fe concentration can be varied over a Fe concentration from <0 to 99<. (see “CONSTITUION of BINARY ALLOYS” by HANSEN 1958 page 713 and pubs by McGraw-Hill). The desired Fe concentration would depend on maximizing the change in resistance do to the neutrino absorption at the Fe sites. Although Fe and Si are preferred, other magnetic impurities, such as Ni, Co and other magnetic elements can be used. Also other materials having the low temperature Kondo effect can be used.

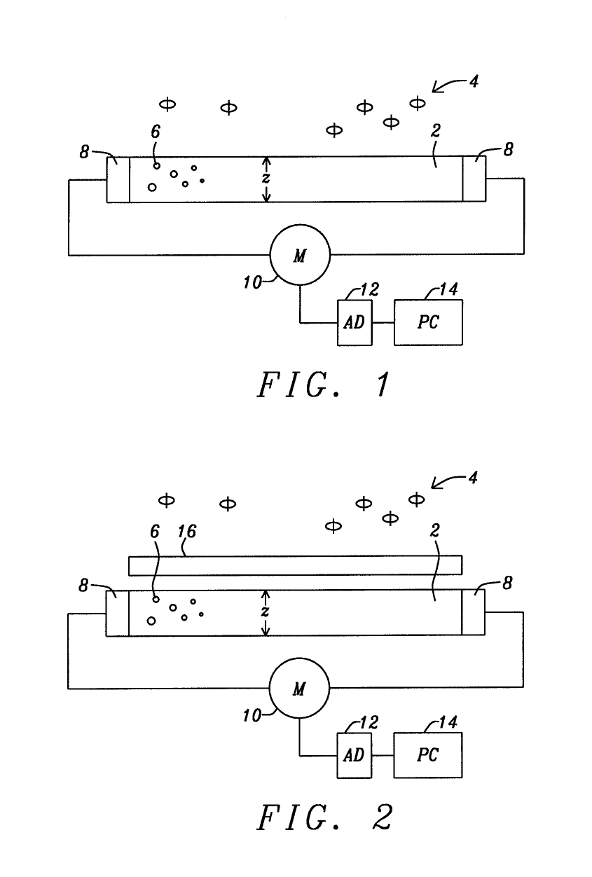

Referring next to FIG. 2 the neutrino detector 2 of FIG. 1 is shown again but includes a shutter 16 to absorb or modulate some of the neutrinos coming from a source. The shutter 16 can be composed of the material (Si doped with Fe) used for the detector 2. To be effective the shutter is also maintained at the same low temperature as the neutrino detector, about 20° Kelvin.

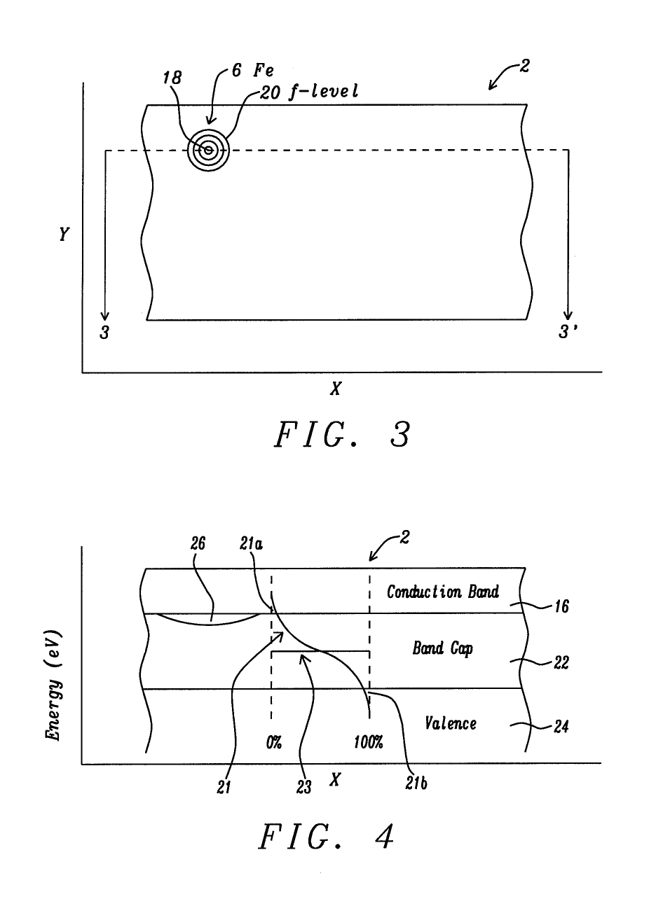

Referring now to FIG. 3, a top view of a portion of the Si substrate 2 of FIG. 1 is shown and labeled along the X and Y axis. While the design of the neutrino detector is shown as a portion having a simple rectangular shape, it should be understood that the neutrino detector can take on other various shapes. For example, the detector can take on shapes such as square, round, and the like. Further the neutrino detector can be increased in thickness, as depicted by Z in FIG. 1, or the Fe doped Si substrates 2 can be stacked (not shown) to increase the number of neutrino detection sites. Although Fe and Si are preferred because of the abundance of these elements on earth and elsewhere in the Universe near stars, other Kondo Insulators or semiconductor alloys can be used, such as Ce₃Bi₄Pt₃, CePd₃ and the like.

Still referring to FIG. 3, a cross section 3-3′ through one of the Fe atoms 6 and Si substrate 2. The other Fe atoms (sites) are omitted to simplify the drawing. The Fe nucleus 18 with a radius of about 5.50×10⁻¹³ cm (centimeter) is at the center of the Fe atom 6 with the atoms outer orbital electrons 20 extending to about 5.50×10⁻⁸ cm. The outer most Fe atomic electron orbit (d and/or f shells) 20 are responsible for forming a shallow micro-band that merges with the Si band structure.

Referring next to FIG. 4, the cross-section through 3-3′ in FIG. 3 is describe in more detail. In this Fig the horizontal axis X remains the distance in the Si substrate 2. However, and important to this disclosure the vertical axis depicts a simplified energy band structure for Si, measured in electron volts (eV). The Fe atom 6 (FIG. 3 above) forms a shallow band 26 that merges with the Si conduction band 16 (heavy electrons) or with the Si band gap 22 (Kondo effect). This shallow energy band 26 formed by the f or d atomic shells (orbital) 20 of the Fe 6 atom 20 in FIG. 3 forms a shallow localized band 26 (˜40-60×10⁻³ eV) that is integrated or hybridized with the conduction band 16 in the Si substrate 2.

Still referring to FIG. 4, and to better understand the function of the neutrino detector 2, a Fermi/Dirac distribution function is shown 21 superimposed over the Si band structure layers 16, 22 and 24 in single crystal silicon, and measured in eV. The energy band labeled 16 is the conduction band, the valence band is labeled 24 and Fermi band gap is labeled 22. When crystals are formed the Paule exclusion principle requires that spin ½ particles do not occupy the same atomic energy levels and therefore form the band structure in solids. The Fermi/Dirac function then shows the distribution of electrons in the solid as a function of temperature. The curve 21 near room temperature (240° K) and the distribution curve 23 near zero degrees Kelvin is shown. At a high temperature, (e.g. 250° K) the portion 21a of the Fermi curve 21 extends into the conduction band 16 and contributes to the conductivity. Also the electrons missing 21b in the valence band 24 contribute positive hole conductivity. The “heavy electrons” associated with the d and f shell electrons (outer orbital electrons at the Fe sites also contribute to the conductively at higher temperatures. When the temperature of the Fe doped Si substrate 2 is reduced to near zero degrees (0°-20° K) the Fermi distribution curve 23 is essentially flat and lies well within the band gap 22. The conduction band 16 is void of electrons and the valence band 24 is filled with electrons. This results in a much lower conductivity a and a higher resistance (receptivity p). The key feature of this device is that at low temperatures the Fe atom's d or f shell electrons are localized at the Fe sites and also do not contribute significantly to the conductivity. At these low temperatures the FeSi neutrino detector is essentially a Kondo insulator.

Referring next to FIG. 5, the function of the neutrino detector 2 is described in more detail using the Kondo insulator results from the paper cited above by Z. Schlesinger et al. titled, “Is FeSi a Kondo Insulator”. Schlesinger's FIG. 1a, page 461 is repeated here for expediency in FIG. 5. This disclosure utilizes this Kondo effect to capture low energy neutrinos to change the conductivity a of the neutrino detector 2.

As shown in FIG. 5 (FIG. 1a of the reference sited above), the vertical axis is the change in the conductivity of FeSi alloy (in reciprocal ohms-cm) as a function of the energy along the horizontal axis as measured in frequency 2πν (cm⁻¹), where the frequency in the electromagnetic (H×E) energy and is related to the Plank's equation by E=hν.

The reference sited above for the Kondo study is a 50/50 atomic percent composition. However, for the purpose of this disclosure the neutrino detector would vary over the composition range from about 1 to 99% for Fe in Si. One can employ a variety of techniques to optimize the properties of the neutrino detector. For example one can use microwave, infrared, Raman absorption spectroscopy techniques to study and optimize the low temperature electronic properties of the detector. Also FeSi is the preferred material because it is compatible with the current day integrated circuit industry.

As shown in FIG. 5, at room temperature (250 K), the conductivity, curve 28, does not change significantly as a function of energy in (at microwave and infrared freq.). Typically, as the temperature decreases the resistivity of semiconductor increases slowly as described above, unlike conductors (metals) that decreases in resistivity because of lattice vibration (phonons). A key feature at these high temperatures is that the resistivety is essentially constant even at very low energy in the millevolt range. Therefore, neutrinos absorbed at the magnet atom sites would not significantly change the resistivity in the detector.

Now referring to curve 30 in FIG. 5, as the temperature of the neutrino detector 2 (in FIG. 4) is reduced below Kondo transition temperature Tₖ the Kondo semiconductor resistivity rapidly increases and becomes a Kondo insulator. More specially, as shown for the FeSi neutrino detector 2 as the temperature is lowered to a near 0 Kelvin (20° K) the conductivity ρ approach zero, curve 30, and is similar to most Kondo insulators. The conductive ρ of the detector 2 increases when low energy neutrinos pass through the Fe site and interact with the “heavy electrons” in the shallow Kondo band 26 (in FIG. 4). The electron mass does not change but in the Fe field (F′=MA) appear to be more massive. The F′ is the modified force from the Fe field.

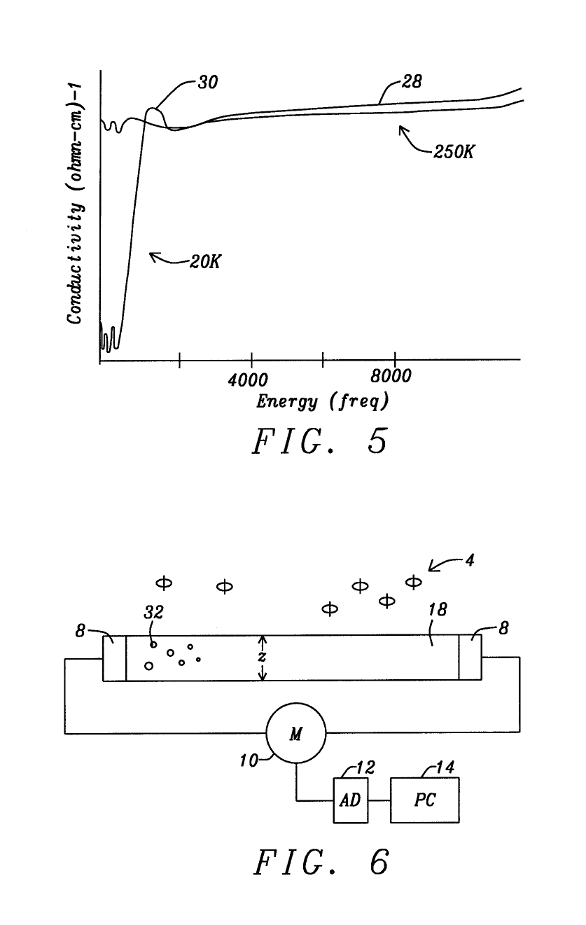

Referring next to FIG. 6, a second embodiment is shown for a neutrino detector. In this embodiment a superconductor material 18 is used to replace the Kondo semiconductor 2, as shown in FIG. 1. For example a high temperature (<78° K) superconductor such as Yttrium Barium Copper Oxide (YBa₂Cu₃O₇₋ₓ) 18 or the like can be used. However, other more conventional low temperature superconductors can also be used that have a transition temperature above the Cosmic Microwave (CMBR) temperatures (3.5° K), such as V₃Si at a temp. <17.1° K, Nb₃Sn and the like with temperatures >than 3.5 K.

Also as described above the superconducting neutrino detector 18 can be monitored using a resistance meter (multimeter) 10 and using an analog-to-digital (A/D) converter and stored on a computer.

This lower temperature superconductor would be practical in outer space. Further, since Si semiconducting integrated circuits function well at low temperatures, a number of these conventional low temperature superconductors can be integrated on the same Si substrates. In this type of neutrino detect a reduction in Cooper pairs 32 would increase the conventional current.

This would result in an increase in resistance when the neutrino detector is in the superconducting state and the neutrino flux increases. The neutrino energy absorbed by the detector would be perceived as also having a change in gravity field.

While the disclosure has been particularly shown and described with reference to the preferred embodiments for detecting neutrinos thereof, it will be understood by one skilled in the art that various changes in form and details may be made without departing from spirit and scope of the disclosure. For example, although FeₓSi_{y} is the preferred alloy and single crystal, other Kondo semiconductors that turn to Kondo insulators can be used near or below the Kondo transition temperature Tₖ. Also, in the second embodiment high temperature superconductors are used. However, superconductors at lower temperatures can also be used that have a transition temperature above the CMBR temperature for used in outer space.

What is claimed is:

1. A neutrino detector device comprised of:
a semiconductor material having magnetic atoms at lattice sites of said semiconductor material;
ohmic metal contacts attached to said semiconductor material to measure the change in resistance due to a change in neutrino flux passing through said semiconductor material;
a multimeter attached to said metal contacts to measure said change in said resistance;
an analog-to-digital (A/D) converter (circuit) attached to said multimeter to convert said change in said resistance to digital storage data for storage on a computer;
said neutrino detector is at a temperature below the Kondo transition temperature.

2. The neutrino detector device of claim 1, wherein said semiconductor material is silicon (Si) and said magnetic atoms are iron (Fe).

3. The neutrino detector device of claim 2 wherein said silicon is a single crystal substrate cleaved along the <100> axis and the concentration of said iron (Fe) varies from <0 to 99 atomic percent.

4. The neutrino detector device of claim 1 wherein said magnetic doping atoms are selected from the group comprising Fe, Co, Ni and Pd.

5. The neutrino detector device of claim 3, wherein said single crystal silicon substrates has a high purity of 99.99999 to 99.9999999 for including integrating circuits on the same said silicon substrate.

6. The neutrino detector device of claim 1, wherein said semiconductor material having magnetic atoms at said lattice sites of said semiconductor material has a Kondo transition temperature above the CMBR temperature (3.5° K).

7. A neutrino detector device comprised of:
A superconducting material;
Ohmic metal contacts attached to said superconducting material to measure the change in resistance due a change in neutrino flux passing through said superconducting material;
a multimeter attached across said ohmic metal contacts to measure said change in resistance;
said multimeter attached to an analog-to-digital (A/D) circuit to store said change in resistance digitally on a computer;
said superconducting material at a temperature below the threshold temperature of said superconducting material.

8. The neutrino detector device of claim 7, wherein said superconductor material are selected from the group that include Lead (Pb) with a transition temperature 7.19° K, Vanadium (V) with a transition temperature 5.03° K, Tantalum (Ta) with a transition (4.48° K).

9. The neutrino detector device of claim 7, wherein said superconductor material are selected from the group that or some compound like V₃Si with a transition temperature 17.1° K, Nb₃Al with a transition temperature 17.5° K and the like which have a critical transition temp. (T_{c}) above the Cosmos Microwave Background Radiation (CMBR) temperature.

10. The neutrino detector device of claim 7, wherein said superconductor material is a means of propulsion measure a change in resistance due to said neutrino passing through said superconductor.

11. The neutrino detector device of claim 1, herein said Kondo insulator is a means of propulsion when said transition temperature is greater than the CMBR temperature (3.5° K).
